(19) United States
(12) Patent Application Publication
(10) Pub. No.: US 2014/0085915 A1
(43) Pub. Date: Mar. 27, 2014

(54) LIGHTING AND/OR SIGNALING DEVICE COMPONENT FOR AUTOMOBILE VEHICLES

(71) Applicants: PIerre Albou, Paris (FR); Marc Brassier, Le Perreux (FR); Jean-Claude Puente, Livry Gargan (FR); Malik Bakacha, Belligne (FR)

(72) Inventors: PIerre Albou, Paris (FR); Marc Brassier, Le Perreux (FR); Jean-Claude Puente, Livry Gargan (FR); Malik Bakacha, Belligne (FR)

(73) Assignee: Valeo Vision, Bobigny Cedex (FR)

(21) Appl. No.: 13/982,513

(22) PCT Filed: Jan. 31, 2012
(86) PCT No.: PCT/EP12/51584

§ 371 Date: Dec. 2, 2013

(30) Foreign Application Priority Data
Feb. 3, 2011 (FR) 1100343

(51) Int. Cl. F21S 8/10

(52) U.S. Cl. CPC F21S 48/10
USPC 362/487; 29/592

(57) ABSTRACT

The present invention relates to a lighting and/or signaling device component for automobile vehicles, comprising a material containing polymer(s) wherein this material locally exhibits, on one face, a region of enhanced reticulation over a superficial thickness.

### CROSS-REFERENCE TO RELATED APPLICATIONS

This application claims priority to PCT Application No. PCT/EP2012/051584 filed Jan. 31, 2012 and French Application No. 1100343 filed Feb. 3, 2011, which are incorporated herein by reference and made a part hereof.

### BACKGROUND OF THE INVENTION

1. Field of the Invention

The present invention relates to a lighting and/or signaling device component, notably a headlamp component, for automobile vehicles.

2. Description of the Related Art

Lighting and/or signaling devices are known that comprise a plastic housing, an outer lens and an optical module each fixed onto this housing. The plastic housing is fixed to the chassis of the vehicle via fixing brackets on this housing. The optical module comprises a lamp, a reflector and a lens in such a manner as to emit a light beam that needs to be correctly adjusted. The lighting device, such as a headlamp, may comprise a support plate. In this case, the optical module is fixed onto the support plate, itself fixed to the housing. Whatever the embodiment, the light beam is adjusted by means of adjustment points situated on the housing.

Thus, the light beam is adjusted for one arrangement of the optical module with respect to the housing (via the support plate or otherwise) and for one arrangement of the housing with respect to the chassis of the vehicle.

The drawback of these devices is that, in operation, heat is diffused, notably over regions such as the adjustment points for the light beam, or the fixing brackets of the housing onto the chassis of the vehicle, or near to the latter, and these regions are subjected to too high a temperature, resulting in a significant thermal expansion of the latter. Consequently, the optical module may move with respect to the housing, and the housing may move with respect to the chassis of the vehicle, in any case leading to a position of the light beam becoming out of adjustment, and hence a modification of the cut-off of the beam.

In certain countries, the adjustment of the light beam is subject to regulations, notably via a test of cut-off stability which comprises, for example, five cycles of illumination for one hour in one position, for example low beam, of the headlamp, each followed by an extinction of one hour. The cut-off stability test is defined in percentage of the stability of the position of the light beam, which must be less than or equal, for example, to around 0.1% for the headlamp in low-beam position, or around 0.3% in the case of a fog lamp.

The thermal expansion of the known devices does not always allow these devices to comply with the tests.

Problems therefore exist in maintaining the adjustment of the position of the light beam in the known lighting devices. One solution to this problem would consist in decreasing the coefficient of thermal expansion of the housing and potentially of the support plate via a judicious choice of the plastic material of the housing and potentially of the support plate in order to increase the stability at the cut-off.

Such an option may not however be envisaged.

Indeed, owing to their location, the lighting and/or signaling devices, and in particular the headlamps, play a big role in the passive safety of vehicles. When an accident happens in which a pedestrian is involved, it is frequently the case that the latter is hit by one of the headlamps of the vehicle. In the case of an adult pedestrian of average height, the part of his/her body coming into direct contact with the headlamp is the hip, which can have serious consequences on the operation of the lower limbs. In the case of a child, it is his/her head which is hit by the headlamp. For this reason, it is necessary for the lighting and/or signaling device to exhibit a relative flexibility in order to provide the optimum cushioning of the impact to the pedestrian or comprises deformable means capable of absorbing the energy of the impact.

Solutions have been put forward. However, these are quite complex and involve, in the majority of cases, the complete revision of the general design of the headlamp, which requires relatively significant human, technical and financial means, and leads to development times often incompatible with the demands of the automobile manufacturers.

What is needed, therefore, is a solution that overcomes one or more problems of the past.

### SUMMARY OF THE INVENTION

The invention aims to provide a lighting and/or signaling device component, notably a headlamp component, for automobile vehicles.

The lighting and/or signaling device component for automobile vehicles, comprises a material polymer(s) wherein, on one face, this material locally exhibits an area of enhanced reticulation over a superficial thickness.

The expression “material containing” is understood to mean a material comprising at least 10% of polymer(s), preferably, at least 15%, more preferably, at least 20%.

“Polymer(s)” is understood to mean thermo-plastic or thermo-hardening polymers, alone or as a mixture, simple or charged with minerals and/or fibers, in particular polymers chosen from amongst the group consisting of polycarbonates (PC), polyamides (PA), acrylonitrile-butadiene-styrene copolymers (ABS), acrylonitrile-styrene-acrylate copolymers (ASA), poly-butylene-terephthalates (PBT), poly-ethylene-terephthalates (PET), polypropylenes (PP), unsaturated polyesters (UP-BMC), polyepoxides (EP), poly-methyl-methacrylates (PMMA), polysulfones (PSU), polyethersulfones (PES) and poly-phenylene-sulfides (PPS).

Preferably, the polymer(s) will be chosen from amongst the group consisting of polycarbonates (PC), polyamides (PA), acrylonitrile-butadiene-styrene copolymers (ABS), acrylonitrile-styrene-acrylate copolymers (ASA), poly-butylene-terephthalates (PBT), polypropylenes (PP), poly-ethylene-terephthalates (PET) and poly-methyl-methacrylates (PMMA).

Even more preferably, the polymers will be chosen from amongst the group consisting of highly-crystalline polypropylene (HCPP), poly-butylene-terephthalates (PBT), simple or charged with minerals and/or fibers, a mixture of poly-butylene-terephthalates and poly-ethylene-terephthalate (PBT+PET), simple or charged with minerals and/or fibers, a mixture of poly-butylene-terephthalates and acrylonitrile-styrene-acrylate (PBT+ASA), a mixture of poly-butylene-terephthalates and polycarbonate (PBT+PC) or a mixture of polypropylene and polyamide (PP+PA), simple or charged with minerals and/or fibers.

According to one embodiment the polymer(s) is(are) highly-crystalline polypropylene (HCPP).

“Enhanced reticulation” is understood to mean a degree of reticulation greater than that of the polymer(s) present in the bulk of a material with respect to the superficial thickness of the material. In general, the degree of reticulation of the polymer or polymers present in the rest of the material will correspond to the degree of reticulation obtained under the usual conditions of polymerization of the polymer or polymers, in other words, without any additional specific treatment of the polymer or polymers. The enhanced reticulation results from the formation of direct bonds between the molecules of polymer(s) forming the material.

For a given group of polymer(s), the degree of reticulation D can be measured by the solubility in a solvent of the polymer. The polymer being soluble in the solvent, the reticulated parts, on the other hand, will be insoluble.

Advantageously, the degree of reticulation is greater by 10%, preferably by 50%, more preferably by 95%, than that of the polymer or polymers present in the rest of the material.

The reticulation of the material can be also determined by DSC (differential scanning calorimetry). A comparison of the treated and untreated material demonstrates that the increase in the degree of reticulation of the material has the effect of making the vitreous transition temperature “Tg” disappear.

“Superficial thickness” is understood to mean a thickness localized on the surface of the face of the material. Advantageously, this thickness is of the order of 5 μm, preferably less than 5 μm, starting from the external surface of the face of the material.

“Locally” is understood to mean one or more region(s) on one face of the material, to the exclusion of the entirety of one face of the material. Preferably, the material comprises first and second faces, connected together by a bulk of the material, the material being potentially bounded by edges which also connect the first and second faces. The region or regions of the face exhibiting an enhanced reticulation are obtained by means of a treatment by ion bombardment applied locally, as will be detailed hereinafter.

In particular, the component according to the invention comprises a material, one face of which is composed of one or more region(s) exhibiting an enhanced reticulation and of one or more regions (the rest of the face) not exhibiting this enhanced reticulation. The two groups thus defined do not have the same mechanical properties, the region(s) exhibiting an enhanced reticulation having an expansion coefficient lower and a rigidity higher than the group formed by the rest of the face not exhibiting an enhanced reticulation. Thanks to a localized treatment, the same material therefore exhibits different properties, and certain regions may be rigidified in order to fix the setting of the light beam, whereas others conserve their property of flexibility and their capacity for absorbing energy in order to handle the pedestrian impact. The behavior of the material thus treated can be close to a composite material without however involving the complexity of implementation and the costs generated by such a material.

When the material is highly-crystalline polypropylene, a material particularly advantageous in the case of an impact with a pedestrian, it was observed that the rigidification by ion treatment of certain regions, critical for the adjustment of the light beam, only had a small influence on the behavior of the material in the case of an impact with a pedestrian. The capacity for absorbing the energy of the impact and the overall deformability of the component was hardly modified (see example 2).

Advantageously, the component is composed of the material.

The automobile vehicle component according to the invention can also be characterized by the presence on one or more regions of a face of the material containing polymer(s) having a thickness exhibiting a decrease in the fraction of the free volume of the material.

The free volume is the volume of material not occupied by the polymer(s). The free volume is measurable for example by SAXS (acronym for “Small Angle X-Ray Scattering”). The fraction of free volume of a polymer is generally in the range between 0.6 and 0.4. In contrast, in the material according to the invention, the superficial thickness of the material of the component according to the invention will have a fraction of free volume less than 0.4, preferably in the range between 0.2 and 0.01.

The lighting and/or signaling device component for automobile vehicles according to the invention is able to be obtained by the method comprising the steps consisting in:
forming the component comprising a material containing polymer(s),
locally treating one face of the material by ion bombardment.

In particular, the whole of the face of the material is not treated. The face therefore comprises one or more untreated regions.

An installation allowing the treatment of an object by ion bombardment is already known in the prior art, notably from FR-A-2 899 242.

The treatment by ion bombardment allows ions to be incorporated into the object in order to treat its surface. In the case of polymers, the treatment by ion bombardment will allow a three-dimensional lattice of polymer(s) to be created on the surface of the material by creating bridges between the macromolecular chains and, on the other hand, certain molecules with low molecular weights (oligomers or additives) present in the material to be grafted. Preferably, the treatment by ion bombardment will enable a reticulation resulting from direct bonds between the molecules of polymer(s). A superficial thickness exhibiting an enhanced reticulation resulting from direct bonds between the molecules of polymer(s) is thus obtained on the material composing the component.

The treatment by ion bombardment is carried out by means of a device comprising ion bombardment means such as for example those described in FR-A-2 899 242: means forming an ion generator and means forming an ion applicator.

The ion applicator usually comprises means chosen for example from amongst ion beam forming electrostatic lenses, a diaphragm, a shutter, a collimator, an ion beam analyzer and an ion beam controller.

The ion generator usually comprises means chosen for example from amongst an ionization chamber, an electron cyclotron resonance ion source, an ion accelerator and in certain cases, an ion separator.

The ion bombardment is generally carried out under vacuum. For example, FR-A-2 899 242 includes the location of the assembly of the ion bombardment means (ion generator and ion applicator), together with the object to be treated, in a vacuum chamber. Means for pumping out the air are connected to this chamber. These pumping means must allow a relatively high vacuum to be obtained in the chamber, for example of the order of 10⁻² mbar to 10⁻⁶ mbar.

Advantageously, the ion bombardment will be carried out by means of beams of ions coming from a gas such as helium, neon, krypton, argon, xenon, molecular oxygen or nitrogen, alone or as a mixture. Preferably, molecular oxygen and/or molecular nitrogen, more preferably, helium and/or molecular nitrogen, will be used.

Preferably, the ion bombardment will be carried out at a pressure in the range between 1 mbar and 10⁻⁵ mbar, preferably, between 10⁻² mbar and 5·10⁻⁴ mbar, and transferring an energy of the order of 0.1 to 100 keV, preferably 0.3 to 30 keV and an ion dose of 10¹³ to 10¹⁸ ions/cm² to the material.

In order to locally treat a given region, the beam of ions is focused by means of electrostatic lenses and/or of masks shielding the regions not to be treated.

Advantageously, the components targeted by the invention are a lighting and/or signaling device housing or a support plate for an optical module of a lighting and/or signaling device.

Indeed, the housing generally comprises at least one mounting interface comprising means for fixing the housing onto the automobile vehicle and the module onto the housing. In a similar fashion, where there is a support plate, this generally comprises at least one mounting interface comprising means for fixing the support plate onto the housing and the module onto the support plate. The setting of the light beam is therefore dependent on the immobility of the fixing means.

Advantageously, a region of enhanced reticulation includes all of the fixing means of the mounting interface of the housing and/or of the mounting interface of the support plate. Indeed, the mounting interface or interfaces is (are) thus rigidified and the fixing means are then immobilized with respect to one another on their support. Advantageously, these fixing means also comprise means for adjustments of the orientation of the light beam. The latter is then insensitive to the potential effects of the thermal expansion.

Alternatively, the adjustment means are distinct from the fixing means. In this case, it is also advantageous for a reticulation region to include the adjustment means in such a manner as to immobilize them with respect to one another and thus to fix the orientation of the light beam.

According to one embodiment, the component comprises at least one deformation region adjacent to at least one mounting interface, this deformation region being more deformable than the mounting interface in such a manner as to transfer the thermal expansion of this interface to the deformation region.

The invention also covers a lighting and/or signaling device for automobile vehicles comprising a component according to the invention.

The method for fabricating a lighting and/or signaling device component for automobile vehicles comprising a material containing polymer(s) comprises the steps consisting in:
forming the said component comprising a material containing polymer(s),
locally treating one face of the material by ion bombardment.

In particular, not the entirety of the face of the material is treated. The face therefore comprises one or more untreated regions.

This method is particularly advantageous because it allows a component to be obtained made from a material comprising regions having various mechanical properties like a composite material, while at the same time implementing raw materials and a fabrication method that are simple and low cost. For example, the component may be prepared by simple molding of the material (injection or compression molding).

Advantageously, the ion bombardment is carried out with mono- or multi-energetic ions of helium, of argon or of nitrogen, at the pressures and with the energies indicated hereinabove.

The method according to the invention is particularly adapted to the fabrication of lighting and/or signaling components and devices for automobile vehicles.

### BRIEF DESCRIPTION OF THE ACCOMPANYING DRAWINGS

The invention will be better understood upon reading the description that follows, presented solely by way of example and with reference to the appended drawings in which:

FIG. 1 is a cross-sectional view of a component according to the invention;

FIG. 2, shows, schematically and partially, in perspective, an exploded view of a headlamp for automobile vehicles according to one embodiment of the invention;

FIG. 3 shows, schematically and partially, in perspective, a rear view of the headlamp in FIG. 2 according to another variant embodiment;

FIG. 4 shows, schematically and partially, in perspective, a rear view of the headlamp in FIG. 2 according to a further variant embodiment; and

FIG. 5 illustrates the results obtained for the pedestrian impact (force and deformation) for a headlamp according to the invention (HCPP+treated HCPP), a headlamp whose housing is totally made from polypropylene charged with 40% of talc (PPT40) and a headlamp whose housing is made from highly-crystalline polypropylene with no local treatment (HCPP).

### DETAILED DESCRIPTION OF THE PREFERRED EMBODIMENTS

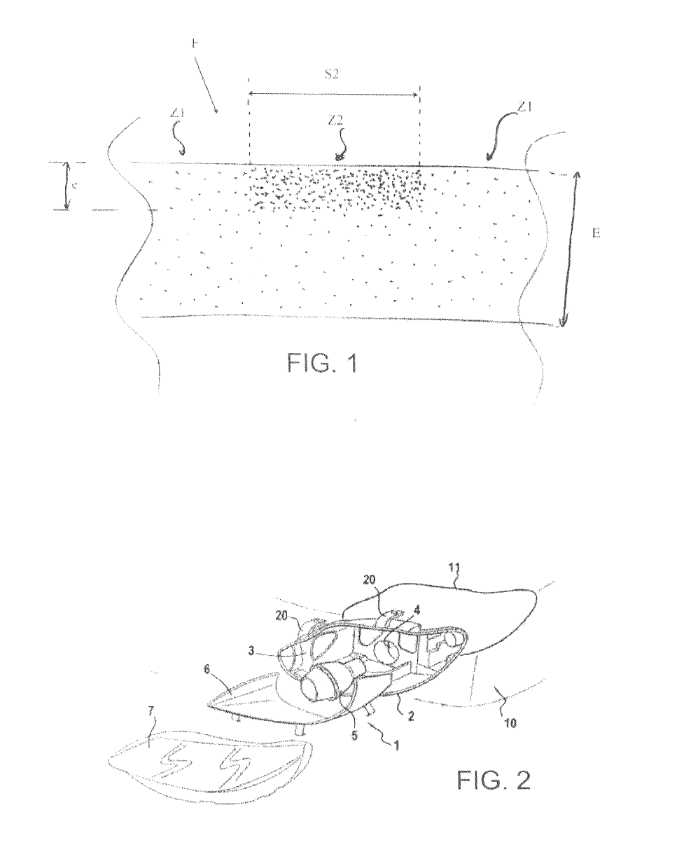

FIG. 1 shows one part of a component according to the invention. In this case, the component is a housing 2 of a lighting device forming a headlamp 1 for automobile vehicles. The housing 2 is composed of a plastic material, for example made of highly-crystalline polypropylene, having a thickness E, and comprises a region Z1 exhibiting a given reticulation. It comprises, locally on one face F a region Z2, extending over a superficial thickness e of the housing, and having an enhanced reticulation. The region Z2 defines a volume of plastic material having an enhanced reticulation of superficial thickness e and having a cross-section corresponding to the external surface S2 of the face F. The superficial thickness e extends from the external surface of the face of the material.

The lighting device forming the headlamp 1 is shown in FIG. 2.

This headlamp 1 comprises a housing 2 made of plastic material, fixed to a chassis 11 of the vehicle 10 via a first mounting interface comprising fixing brackets 20 on the housing 2 and screws (not shown) for fixing these brackets 20 into orifices (not shown) of the chassis 11.

This housing 2 comprises, on the one hand, an opening 3 and, on the other hand, an orifice 4 designed to partially receive an optical module 5 emitting a light beam directed toward this opening 3.

For this purpose, the optical module 5 comprises a lamp, a reflector and a lens (not shown).

The light beam is capable of being representative of a lighting position of the low-beam type.

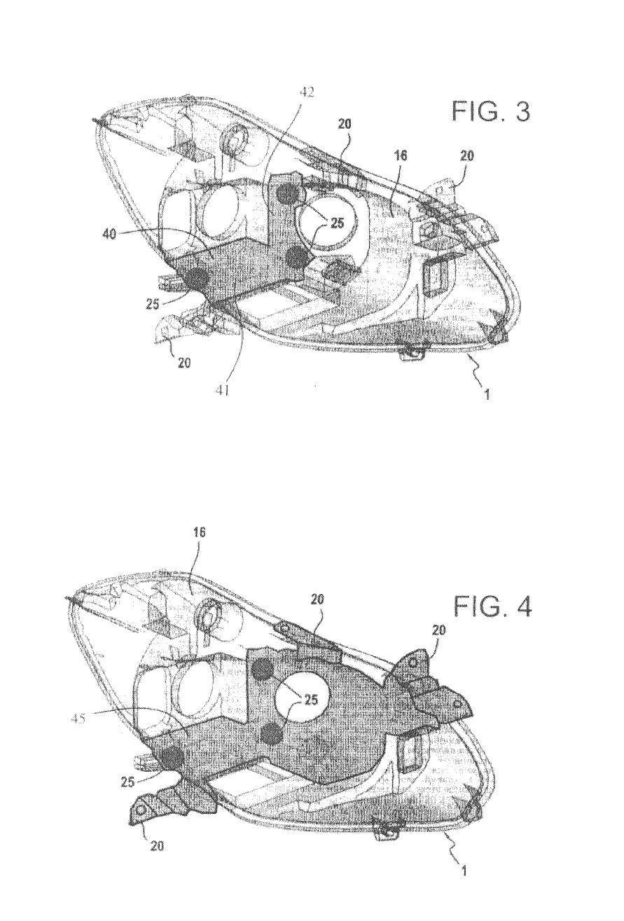

The optical module 5 is fixed to the housing 2 via a second mounting interface comprising, on the one hand, fixing points 25 (shown in FIG. 3) arranged on the housing 2 and, on the other hand, elements (not shown) of the optical module 5.

The housing may of course comprise several optical modules.

The headlamp 1 furthermore comprises, in a known manner, a mask 6 disposed within the housing 2, under the optical module 5, and a lens 7 fixed onto the housing 2 in order to close the opening 3 in a leak-tight manner.

A first example of implementation of one embodiment of the invention will now be described with reference to FIG. 3, this embodiment being designed to decrease the coefficient of thermal expansion of the region comprising the second mounting interface.

In the example described, the headlamp 1 comprises a region 40 of rigidification, generated by local ion treatment of the plastic material in this region 40 of the housing 2. This region 40 consequently has a coefficient of thermal expansion substantially higher than that of the plastic material of the housing 2 outside of this region 40.

This region 40 has a shape comprising two branches 41 and 42 being substantially perpendicular each directed from one common fixing point 25 toward another fixing point 25 of the second interface. Thus, the region 40 runs between the three fixing points 25 of the second mounting interface.

Each fixing point 25 is formed by a hole designed to receive a fixing screw.

If desired, at least one of the fixing points can be adjustable in order to displace the optical module inside of the housing in such a manner as to adjust the position of the light beam.

FIG. 4 illustrates yet another variant embodiment of the headlamp in FIG. 3.

The headlamp in FIG. 4 comprises a region 45 formed by local ion treatment of the plastic material in this region 45 of the housing 2 in order to reduce the coefficient of thermal expansion of two mounting interfaces, in contrast to the region 40 in FIG. 3. These mounting interfaces comprise a first mounting interface for the housing on the vehicle and a second mounting interface for the optical module on the housing.

This region 45 runs, on the one hand, between the fixing points 25 of the second mounting interface and, on the other hand, from each of the fixing points 25 as far as each fixing bracket 20 of the first mounting interface.

In contrast to the region 40 in FIG. 3, the region 45 therefore comprises the three fixing brackets 20 for the first mounting interface and thus participates in the mounting of the housing 2 on the chassis 11 of the vehicle 10.

### Example 1

### Method for Local Treatment of One Part of a Headlamp Housing

The component, a housing made of polypropylene charged with 36% by weight of talc, is implemented by injection molding. This component is inserted into a chamber, equipped with an ion implantation apparatus comprising a system for scanning by controlled electrostatic lenses.

The parameters of the ion implantation are as follows:

Gas: Helium
Source: ECR (electron cyclotron resonance)/microwave
Treatment energies received by the component: 20 keV
Ion dose: 10¹⁶ ions/cm²
Treatment time: 3 s/cm²
Surface area of the beam: 1 cm²
Working pressure (P): 1·10⁻³ mbar.

### Example 2

### Comparative Testing with a Headlamp According to the Invention

Measurements are performed on the headlamp such as described in FIG. 4 (HCPP+treated HCPP) and compared with a headlamp whose housing is entirely made of polypropylene charged with 40% of talc (PPT40) usually used and a headlamp whose housing is made from a highly-crystalline polypropylene not locally treated (HCPP).

A. Pedestrian Impact

The pedestrian impact test makes reference to an impact test by an impactor, representative of a pedestrian, on a headlamp fixed onto its car body support. Such a test is generally defined within the regulatory directives of the country.

The calculation is carried out using a finite element processing software application of the explicit type adapted to calculations of short-duration impacts. The calculation method used allows predictive calculations to be performed in line with the results of the tests in question. The results obtained are described by a curve characteristic of the impact referred to as an energy curve of the impactor force type, which is a function of the deformation of the latter. The force curve=f(deformation) represents the behavior during the impact. The energy absorption corresponds to the area under the curve.

The aim is to minimize the participation force of the headlamp to the global contribution of the vehicle in the case of the impacts handled by the invention or, in contrast, to selectively reinforce certain impact regions by ion bombardment, so as to increase the capacity for energy absorption without however causing injuries to the pedestrian.

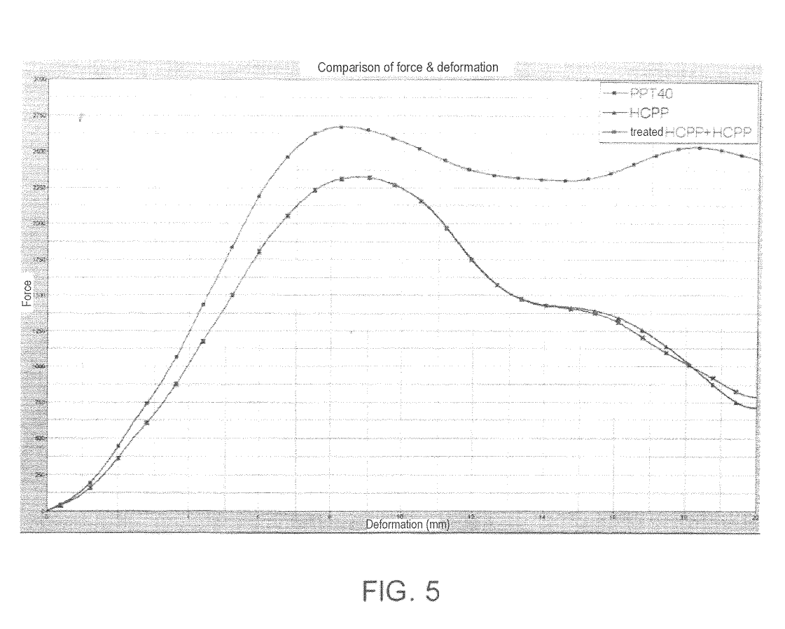

FIG. 5 shows the results of the pedestrian impact test in the case of housings made of polypropylene charged with 40% by weight of talc (PPT40), made of untreated highly-crystalline polypropylene (HCPP) and made of highly-crystalline polypropylene comprising a region treated as is indicated in FIG. 5 (HCPP+treated HCPP).

Conclusion:

Owing to its flexibility and its capacity for absorbing impacts, highly-crystalline polypropylene is a material particularly well adapted to handling pedestrian impacts. However, it does not possess a high enough rigidity to be used as such in the fabrication of a headlamp housing.

As is demonstrated in FIG. 5, the results obtained with the headlamp according to the invention and a headlamp made of untreated HCPP are similar. Consequently, the local treatment has no or no effect on the pedestrian impact.

B. Cut-Off Stability

The regulations relating to the cut-off stability impose the verification of the variation of the cut-off position after an illumination of 1 hour with low beam. This must not vary by more than 1 mrad (0.1%) with respect to its initial position.

The table hereinbelow summarizes the results obtained on the 3 configurations and 2 types of product.

| Reference | Configuration 1 | Configuration 2 | Configuration 3 |
|---|---|---|---|
| Product 1 | −0.09% | −0.14% | −0.09% |
| Product 2 | −0.09% | −0.10% | −0.09% |

Configuration 1: Housing PP T40
Configuration 2: Housing HCPP
Configuration 3: Housing HCPP + treated HCPP

The results correspond to the variation of the cut-off position after a test of 1 hour with low beam. It can notably be seen that, for the configuration 1 and the configuration 3, the variation is acceptable, since lower than the aforementioned threshold of 1%.

Conclusion:

The tests of cut-off stability aim to characterize the thermo-mechanical stability of the low-beam position of the headlamp under prolonged illumination. The advantages of the material (HCPP+treated HCPP) allow the degradation in the coefficient of thermal expansion of the HCPP in the identified localized regions in the example 2A to be mitigated. Thus, the results of cut-off stability with a housing made of locally treated HCPP are identical to those of a housing made of PPT40.

Thus, the advantages highlighted in the example 2A are compatible with the requirements of cut-off stability.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting and/or signaling device component for automobile vehicles, comprising a material containing polymer(s) wherein, on one face, this material locally exhibits an area of enhanced reticulation over a superficial thickness.

2. A lighting and/or signaling device component for automobile vehicles, able to be obtained by the method comprising the steps comprising:
forming the said component comprising a material containing polymer(s); and
locally treating one face of the material by ion bombardment.

3. The component according to claim 1, said component being a housing for a lighting and/or signaling device or a support plate for an optical module for a lighting and/or signaling device.

4. The component according to claim 3, comprising at least one mounting interface comprising means for fixing the housing onto the vehicle and/or the support plate onto the housing and/or the optical module onto the housing and/or the optical module onto the support plate and in which the region of enhanced reticulation includes the means for fixing the mounting interface.

5. The component according to claim 3, comprising at least one deformation region adjacent to at least one mounting interface, this deformation region being more deformable than the mounting interface in such a manner as to transfer the thermal expansion of this interface to the deformation region.

6. The component according to claim 1, in which the polymer(s) is(are) chosen from amongst the group consisting of highly-crystalline polypropylene (HCPP), poly-butylene-terephthalate (PBT) simple or charged with minerals and/or fibers, a mixture of poly-butylene-terephthalate and poly-ethylene-terephthalate (PBT+PET), simple or charged with minerals and/or fibers, a mixture of poly-butylene-terephthalate and acrylonitrile-styrene-acrylate (PBT+ASA), a mixture of poly-butylene-terephthalate and polycarbonate (PBT+PC) or a mixture of polypropylene and polyamide (PP+PA), simple or charged with minerals and/or fibers.

7. The component according to claim 6, in which the polymer(s) is(are) highly-crystalline polypropylene (HCPP).

8. The lighting and/or signaling device for automobile vehicles comprising a component according to claim 1.

9. A method for fabricating a lighting and/or signaling device component for automobile vehicles comprising a material containing polymer(s) comprising the steps of:
forming the said component comprising a material containing polymer(s); and
locally treating one face of the material by ion bombardment.

10. The method according to the claim 9, in which the component is formed by molding.

11. The method according to claim 9, in which the ion bombardment is carried out with mono- or multi-energetic ions of helium, of argon or of nitrogen.

12. The method according to claim 9, for fabricating a lighting and/or signaling device component for automobile vehicles, comprising a material containing polymer(s) wherein, on one face, this material locally exhibits an area of enhanced reticulation over a superficial thickness.

13. The method according to claim 10, for fabricating a lighting and/or signaling device component for automobile vehicles, comprising a material containing polymer(s) wherein, on one face, this material locally exhibits an area of enhanced reticulation over a superficial thickness.

14. The component according to claim 2, said component being a housing for a lighting and/or signaling device or a support plate for an optical module for a lighting and/or signaling device.

15. The component according to claim 4, comprising at least one deformation region adjacent to at least one mounting interface, this deformation region being more deformable than the mounting interface in such a manner as to transfer the thermal expansion of this interface to the deformation region.

16. The component according to claim 3, in which the polymer(s) is(are) chosen from amongst the group consisting of highly-crystalline polypropylene (HCPP), poly-butylene-terephthalate (PBT) simple or charged with minerals and/or fibers, a mixture of poly-butylene-terephthalate and poly-ethylene-terephthalate (PBT+PET), simple or charged with minerals and/or fibers, a mixture of poly-butylene-terephthalate and acrylonitrile-styrene-acrylate (PBT+ASA), a mixture of poly-butylene-terephthalate and polycarbonate (PBT+PC) or a mixture of polypropylene and polyamide (PP+PA), simple or charged with minerals and/or fibers.

17. The component according to claim 4, in which the polymer(s) is(are) chosen from amongst the group consisting of highly-crystalline polypropylene (HCPP), poly-butylene-terephthalate (PBT) simple or charged with minerals and/or fibers, a mixture of poly-butylene-terephthalate and poly-ethylene-terephthalate (PBT+PET), simple or charged with minerals and/or fibers, a mixture of poly-butylene-terephthalate and acrylonitrile-styrene-acrylate (PBT+ASA), a mixture of poly-butylene-terephthalate and polycarbonate (PBT+PC) or a mixture of polypropylene and polyamide (PP+PA), simple or charged with minerals and/or fibers.

18. The component according to claim 5, in which the polymer(s) is(are) chosen from amongst the group consisting of highly-crystalline polypropylene (HCPP), poly-butylene-terephthalate (PBT) simple or charged with minerals and/or fibers, a mixture of poly-butylene-terephthalate and poly-ethylene-terephthalate (PBT+PET), simple or charged with minerals and/or fibers, a mixture of poly-butylene-terephthalate and acrylonitrile-styrene-acrylate (PBT+ASA), a mixture of poly-butylene-terephthalate and polycarbonate (PBT+PC) or a mixture of polypropylene and polyamide (PP+PA), simple or charged with minerals and/or fibers.

19. The lighting and/or signaling device for automobile vehicles comprising a component according to claim 2.

20. The method according to claim 10, in which the ion bombardment is carried out with mono- or multi-energetic ions of helium, of argon or of nitrogen.
